(19) United States
(12) Patent Application Publication
(10) Pub. No.: US 2020/0142182 A1
(43) Pub. Date: May 7, 2020

(54) MEMS Optical Switch with Micro Optical Filters

(71) Applicant: East Point Communication Technology Company, Ltd., Shenzhen (CN)

(72) Inventor: Chaozhi Qi, Shenzhen (CN)

(73) Assignee: East Point Communication Technology Company, Ltd., Shenzhen (CN)

(21) Appl. No.: 16/179,446

(22) Filed: Nov. 2, 2018

(51) Int. Cl. G02B 26/08; G02B 5/20

(52) U.S. Cl. CPC G02B 26/0833; G02B 26/0875; G02B 5/201

(57) ABSTRACT

A MEMS optical switch with micro optical filters using is disclosed. The optical switch provides any-to-any non-intrusive multi-layer optical switching using micro optical filters such as micromirrors and micro-lenses activated and deactivated using MEMS technology. 3-D optical switches using the same switching design can also be constructed by combining multiple MEMS optical switches together.

### TECHNICAL FIELD

This invention relates to MEMS optical switches. More specifically, this invention relates to MEMS optical switches with micro optical filters.

### BACKGROUND OF THE INVENTION

The telecommunications and connectivity technologies have been rapidly developing new methods in order to meet customers' demand for faster data speed and higher throughput of data traffic. Technologies such as mobile data, video-on-demand, social media and so on pose new challenges to data traffic management and drive innovations that address problems in high speed data processing.

In data intensive applications, such as those found in datacenters, data traffic is increasingly being processed in optical medium instead of conventional electrical medium. That is because optical communications have many advantages over traditional communication methods in terms of having high data throughput, low costs, small formfactors etc. Optical based data traffic has increasingly becoming a critical form of data traffic in those applications.

One critical process in managing high data traffic is data switching, i.e. distributing received incoming data to their destinations for use or further processing. Switches are specifically designed with regard to the underlying type of signal it processes. For optical data switching, optical switches must be used. Among the many different types of optical switches, Micro Electronics Mechanics System (“MEMS”) optical switch is a popular choice. MEMS devices are electromechanical devices with microscopic moving parts driven by very small electric currents. Conventionally, MEMS optical switches manage optical data traffic by using reflective micromirrors. In MEMS optical switches, optical signals propagate in short free space between the transmitter and the receiver, or transceivers, located on the optical paths, or propagation paths, of the optical signals. When it is determined that switching is needed for an optical signal, the MEMS optical switch is activated and places a micromirror on the optical signal's free space propagation path, optically switching the optical signal to the destination transceiver located on the switched free space path.

Conventional optical switches have many disadvantages, including: channel interferences when providing an any-to-any switching, slow switching speed; lack of wavelength selection and express channel for pass-through, switching restrictions brought by refection-only micromirrors, fixed array of transceiver that cannot be individually replaced, vulnerability in switch malfunctions when there is power outage, limited scalability, limited capability in adjusting power splitter ratio, signal monitoring and tapping, complicated design in channel arrays and costly maintenance and upgrade.

As such, there is a need for a MEMS optical switch that overcomes the disadvantages of the conventional switches.

### SUMMARY OF THE INVENTION

An object of the present invention is to provide a MEMS optical switch. The switch includes plurality of optical transceivers in a 2D plane comprising an X-axis and a Y-axis with m pairs of optical transceivers lining along the Y-axis and n pairs of optical transceivers lining along the X-axis, wherein each transceiver of a pair is located on an optical path across an optical filter matrix of another transceiver of said pair; an optical filter matrix comprising m×n micro optical filter units, wherein each micro optical filter unit is located on a cross point of optical paths of an X-axis transceiver pair and Y-axis transceiver pair man optical filter matrix board on which the optical filter matrix is located; and a controller configured to provide MEMS control signals. Each micro optical filter unit of the MEMS optical switch is configured to be able to be activated by the MEMS control signals and switching optical signals transmitted through the cross point where the micro optical filter unit is located.

According to this object of the present invention, each micro optical filter unit further includes: a micro optical filter assembly configured to be movable within a unit frame of said micro optical filter assembly.

Further according to this object of the present invention, the micro optical filter assembly further includes: a rotation shaft; and at least one micro optical filter attached to the rotation shaft. The rotational shaft is configured to be rotatable to place the at least one optical filter to one of an optical path space and an inactive space.

Further according to this object of the present invention, the micro optical filter assembly further includes: at least one tail rod; and a plurality of magnetic tabs attached to the at least one tail rods, wherein at least one of the magnetic tabs is of a magnetic north and at least one of the magnetic tabs is of a magnetic south. An electro-magnetic field may be actuated in accordance with the MEMS control signal, said electro-magnetic field interacts with the plurality of magnetic tabs and drives the rotation shaft to place one of the at least one micro optical filter to the optical path space.

Further according to this object of the present invention, the MEMS optical switch may further include one micro optical filter and two magnetic tabs. When the electro-magnetic field is not actuated, the micro optical filter is located in the inactive space. Alternatively, the MEMS optical switch may include two micro optical filters, and three magnetic tabs, wherein when the electro-magnetic field is not actuated, the two micro optical filters are located in the inactive space. Further alternatively, the MEMS optical switch may include three micro optical filters, and four magnetic tabs, wherein when the electro-magnetic field is not actuated, the three micro optical filters are located in the inactive space. Still further alternatively, the MEMS optical switch may include a stepper motor attached to the rotation shaft, wherein the stepper motor is configured to drive the rotation shaft to place one of the at least one micro optical filter to the optical path space.

Further according to this object of the present invention, the at least one micro optical filter may be a micromirror, a coated micro lens, wherein the coated micro lens reflects a first plurality of wavelengths and passes a second plurality of wavelengths, or may include two micro lenses in contact with each other on a tilted coated surface with a tilting angle θ, wherein the micro optical filter reflects a first plurality of wavelength to an angle adjusted by the tilting angle 9 and passes a second plurality of wavelengths.

According to another object of the present invention, a 2D MEMS optical switch is provided herein, which includes: a plurality of free space optical paths in a 2D plane including an X-axis and a Y-axis with m horizontal optical paths and n vertical optical paths; l pairs of optical transceivers located on the m horizontal paths, wherein l<m, and k pairs of optical transceivers located on the n horizontal paths, wherein k<n, wherein each transceiver is located on an optical path across an optical filter matrix of another transceiver of said pair, and wherein at least one pair of the l pairs of transceivers and the k pairs of vertical optical is configured to be moveable and transmits optical signals on at least two optical paths; the optical filter matrix including m×n micro optical filter units, wherein each micro optical filter unit is located on a cross point of optical paths of an X-axis transceiver pair and Y-axis transceiver pair; an optical filter matrix board on which the optical filter matrix is located; and a controller configured to provide MEMS control signals, wherein each micro optical filter unit is configured to be able to be activated by the MEMS control signals and switching optical signals transmitted through the cross point where the micro optical filter unit is located.

Further according to the other object of the present invention, each micro optical filter unit further includes a micro optical filter assembly configured to be movable within a unit frame of said micro optical filter assembly.

Further according to the other object of the present invention, the micro optical filter assembly includes: a rotation shaft; at least one micro optical filter attached to the rotation shaft, wherein the rotational shaft is configured to be rotatable to place the at least one optical filter to one of an optical path space and an inactive space.

Further according to the other object of the present invention, the micro optical filter assembly may further includes: at least one tail rod; and a plurality of magnetic tabs attached to the at least one tail rods, wherein at least one of the magnetic tabs is of a magnetic north and at least one of the magnetic tabs is of a magnetic south, wherein an electro-magnetic field may be actuated in accordance with the MEMS control signal, said electro-magnetic field interacts with the plurality of magnetic tabs and drives the rotation shaft to place one of the at least one micro optical filter to the optical path space.

Further according to the other object of the present invention, the micro optical filter assembly may further include a stepper motor attached to the rotation shaft, wherein the stepper motor is configured to drive the rotation shaft to place one of the at least one micro optical filter to the optical path space.

Further according to the other object of the present invention, the at least one micro optical filter includes two micro lenses in contact with each other on a tilted coated surface with a tilting angle θ, wherein the micro optical filter reflects a first plurality of wavelength to an angle adjusted by the tilting angle θ and passes a second plurality of wavelengths.

Yet another object of the present invention is to provide a 3D MEMS optical switch, including a plurality ﬀ optical transceiver layers. Each layer including a plurality of optical transceivers in a 2D plane comprising an X-axis and a Y-axis with m pairs of optical transceivers lining along the Y-axis and n pairs of optical transceivers lining along the X-axis, wherein each transceiver of a pair is located on an optical path across an optical filter matrix of another transceiver of said pair; the optical filter matrix comprising m×n micro optical filter units, wherein each micro optical filter unit is located on a cross point of optical paths of an X-axis transceiver pair and Y-axis transceiver pair; an optical filter matrix board on which the optical filter matrix is located; and a controller configured to provide MEMS control signals; wherein each micro optical filter unit is configured to be able to be activated by the MEMS control signals and switching optical signals transmitted through the cross point where the micro optical filter unit is located.

Further according to the yet another object of the present invention, an optical filter unit is further configured to be able to switch optical signals transmitted from a first transceiver located in a first layer of the MEMS optical switch to a second transceiver located in a second layer of the MEMS optical switch.

As such, the present invention provides a main switching mechanism using electro-magnetic pole activation. It provides a non-intrusive any-to-any matrix based optical switch without channel interference.

Another advantage of the present invention is that it provides a fast optical switch with switching speed in the range of micro- to mini-seconds.

Yet another advantage of the present invention is the switching mechanism covers optical channel path change, wavelength selection and express channel for pass-through channels.

Yet another advantage of the present invention is to provide an optical switch using lens interface, wherein each lens interface may provide a multi-way channel cross-connect.

Yet another advantage of the present invention is to provide optical transmitters and receivers that can be individually replaced.

Yet another advantage of the present invention is that the optical switch can be extended to 3D and multi-directions using different layers of optical coatings on the lens.

Yet another advantage of the present invention is to provide an optical switch that can provide an adjustable power splitter ratio, signal monitoring and tapping.

Yet another advantage of the present invention is to provide an optical switch, wherein each of the channels can be replaced or upgraded separately.

### BRIEF DESCRIPTION OF THE DRAWINGS

The above-mentioned advantages and other features of the present invention will become more apparent to and the invention will be better understood by people skilled in the art with reference to the following description of the preferred embodiments of the invention taken in conjunction with the accompanying drawings, wherein:

FIG. 1 is a top view of a schematic diagram of the MEMS optical switch with micro optical filters according to a preferred embodiment of the present invention.

FIG. 2 is a schematic top view of a micro optical filter unit 200 of the matrix 120.

FIG. 3A is a perspective view of an embodiments of the micro optical filter assembly 300.

FIG. 3B is a perspective view of another embodiments of the micro optical filter assembly 300.

FIG. 3C is a perspective view of yet another embodiments of the micro optical filter assembly 300.

FIG. 3D is a perspective view of still another embodiments of the micro optical filter assembly 300.

FIG. 4A is a schematic side view of an embodiment of the micro optical filters.

FIG. 4B is a schematic side view of another embodiment of the micro optical filters.

FIG. 4C is a schematic side view of yet another embodiment of the micro optical filters.

FIG. 5 is a schematic perspective view of a 3D MEMS micro optical filter switch according to another preferred embodiment of the present invention.

### DETAILED DESCRIPTION OF THE PREFERRED EMBODIMENTS

One or more embodiments are illustrated by way of example, and not by limitation. In the figures of the accompanying drawings, elements having the same reference numeral designations represent like elements throughout. The drawings are not to scale, unless otherwise noted. It is to be understood that all terminologies and phraseology used herein are for the purpose of illustration and should not be understood as limiting. The phrases such as “including”, “comprising”, “having” and other variations thereof are meant to encompass the items as described, their equivalents without excluding any additional items thereof.

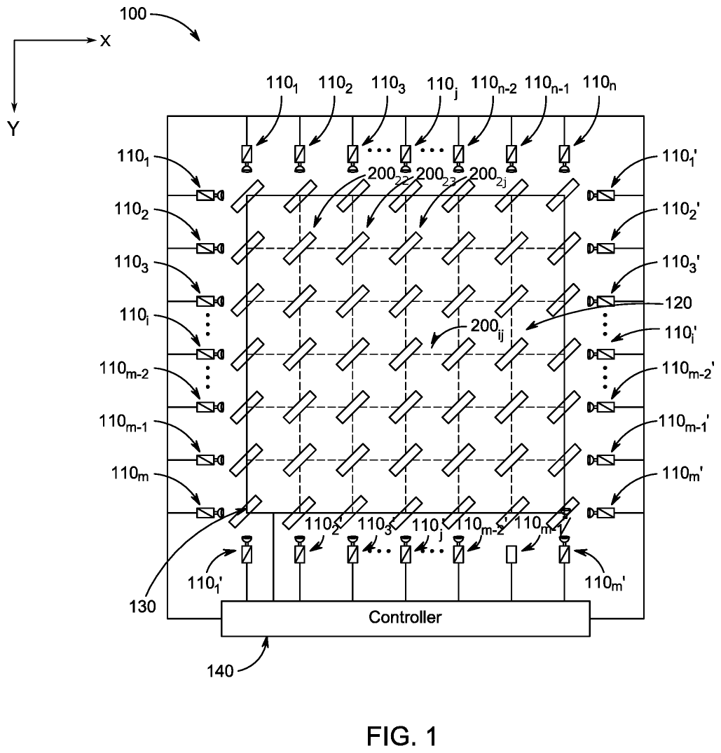

FIG. 1 is a top view of a schematic diagram of the MEMS optical switch with micro optical filters according to a preferred embodiment of the present invention. Referring to FIG. 1, the MEMS optical switch with micro optical filters 100 (hereinafter “the MEMS switch 100” or “the switch 100”) includes a plurality of optical transceivers 110, including all items starting with the numerical “110” in FIG. 1, which will be described in further detail below. The plurality of optical transceivers 110 are lined up to in surrounding a micro optical filter matrix 120. The micro optical filter matrix 120 comprises a matrix of micro optical filter units 200, including all items starting with the numerical “200” in FIG. 1,, which will be described in further detail below. Micro optical filter matrix 120 located on micro optical filter matrix board 130, which provides a physical framework in support of the operation of the micro optical filter matrix 120. The MEMS switch 100 further includes controller 140, which provides control signals to the system. The top view of the MEMS switch 100 is in a 2D plane consisting an X-axis and a Y-axis as illustrated in FIG. 1. A Z-axis of the 3-dimentional (hereinafter “3D”) space the MEMS switch 100 is located is not shown herein. People skilled in the art will appreciate that the Z-axis is perpendicular to the 2D plane. The various components of the MEMS switch 100 will now be described in further detail below.

According to a preferred embodiment of the present invention, all of the optical transceivers 110 are of the same type. There are a total number of 2m+2n optical transceivers 110 lining up the rectangular peripheral of the optical filter matrix 120. Parallel to the Y-axis, i.e. the vertical axis illustrated in FIG. 1, there are m pairs of transceivers, i.e. 110_{Y1}, 110_{Y2}, . . . , 110_{Ym} located on the left side of the micro optical filter matrix 120 and 110_{Y1′}, 110_{Y2′}, 110_{Ym′} located on the right side of the micro optical filter matrix 120 (hereinafter collectively “Y-transceivers”). The Y-transceivers on the left and right sides face each other and are placed in m pairs, wherein the paired Y-transceivers are in each other's free space optical propagation path to transmit and receive optical signals to and from each other when no optical switch is placed on the optical propagation path.

Similarly, parallel to the X-axis, i.e. the vertical axis illustrated in FIG. 1, there are n pairs of transceivers, i.e. 110ₓ₁, 110ₓ₂, . . . , 110ₓₙ located on the up side of the micro optical filter matrix 120 and 110_{x1′}, 110_{x2′}, . . . 110_{xn′} located on the bottom side of the micro optical filter matrix 120 (hereinafter collectively “X-transceivers”). The X-transceivers on the up and bottom sides face each other and are placed in n pairs, wherein the paired X-transceivers are in each other's free space optical propagation path to transmit and receive optical signals to and from each other when no optical switch is placed on the optical propagation path.

As such, people skilled in the art will appreciate that the MEMS switch 100 has a total of m horizontal free-space optical paths and n vertical free-space optical paths crossing each other at m×n cross points. According to an embodiment of the present invention, at each of the cross point, a micro optical filter unit 200 is placed therein to switch any optical signals transmitted freely on one optical path. The micro optical filter units will be described in more detail later.

As illustrated in FIG. 1, the MEMS micro optical filter matrix 120 (hereinafter “matrix 120”) is located in the center surrounded by the transceivers 110. The matrix 120 comprises a total number of m×n micro optical filter units 200₀₀, 200₀₁. . . , 200₁ₙ, 200₁₁ . . . 200ₘₙ (hereinafter collectively “optical filter units 200”), each located at a cross point of the free space optical paths of the transceivers 110. All of the micro optical filter units 200 are attached to the micro optical filter matrix board 130, which is on the same 2D plane of the switch 100. The matrix board 130 provides mechanical support, operating space, as well as control signal circuitry for each of the micro optical filter units 200 of the matrix 120.

According to the preferred embodiment of the present invention, all optical signals travels to one side of the matrix board 130, whereas no optical signal travels to the other side of the matrix board 130. As such, the space where the optical signals are transmitted on the optical paths between the transceivers is denoted as the optical path space, and the space where no optical signals will be transmitted is denoted as the inactive space. For convenience, the optical path space may also be referred to as the upper side of matrix board 130 and the inactive space may be referred to as the lower side of the matrix board 130.

Depending on the space each micro optical filter unit 200 of matrix 120 is in, the micro optical filter 200 may either in an active state and an inactivate state. When all of the micro filters in a micro optical unit 200 stay in the inactive space, the micro optical unit 200 is said to be in an inactive state. Whereas when at least one of the micro filters in a micro optical unit 200 is in the optical path space, the micro optical unit 200 is said to be in an active state. Therefore, when a micro optical unit 200 is inactive, all of its micro filters stay below matrix board 130; whereas when a micro optical unit is active, at least one of its micro filters is above the matrix board 130 in the optical path space. During the process of activation, at least one of the micro optical filters will be moved from the inactive space and placed at the corresponding cross point in the optical path space where the micro optical unit 200 is located. Detailed description of the structure and operation of the matrix 120, matrix board 130 and the micro optical filter units 200 will be described in more detail later.

Controller 140 provides control signals for the MEMS switch 100. The control signals may be generated by the controller 140 or received from other computing units. Controller 140 provides control signals to all components of MEMS switch 100, including all transceivers 110, the micro optical filter matrix 120 comprising micro optical filter units 200, and the matrix board 130. The controller signals are derived by algorithm taking into account information such as the need and requirement of the system, network traffic, the type of the optical filters, pre-conditions etc. and provided appropriate to all relevant components for coordinating the desired optical data switching. It will be appreciated by people skilled in the art that controller 140 is schematically rendered in FIG. 1. In other embodiments, controller 140 may be placed in other locations in the MEMS switch 100, or consist of several components, each located at a different location. It may either generate control signal locally or use control signal received from other computing units not shown in FIG. 1. The circuitry of the controller connecting to the rest of the components of the MEMS switch 100 can also have various layouts. It is understood by people skilled in the art that all these variations on the controller 140 are within the scope of the present invention.

According to another embodiment of the present invention not shown in FIG. 1, the MEMS switch 100 of a m xn micro optical filter matrix 120 may have less than m transceiver pairs on the Y-axis and/or less than n transceiver pairs on the X-axis. According to these embodiments, some or all of the transceivers are configured to move along their respective axes in a predetermined range. As such, a transceiver may provide optical signals to more than one optical path. For example, there may be only one transceiver pair located on the Y-axis. This single pair of transceivers may move along the sides of a matrix 120 comprising m xn micro optical filters units and may stop at any of the m horizontal optical paths. People skilled in the art will appreciate that the single moveable pair transceiver can accomplish almost all functions of an optical switch system comprising m pairs of Y-transceivers by originating or receiving the optical signals on the m horizontal paths in a serial manner. Alternatively, there may be more than one transceiver pairs on each axis, each covering a number of optical paths. There may be any number of transceiver pairs on each of the X- and Y-axis in the range of 1 to m on the -axis and 1 to n on the X-axis. These embodiments can be implemented using well-known or obvious prior art methods such as by including sliding tracks and respective sliding components on the movable transceivers to cover more than one optical path. Other electrical and/or mechanical designs may be provided to facilitate the moving of the transceiver, which are also within the scope of the present invention.

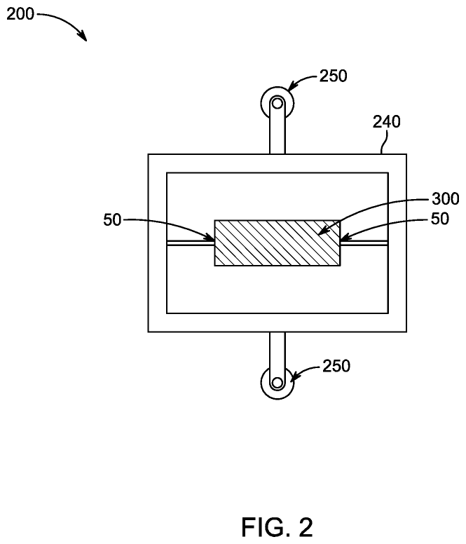

FIG. 2 is a schematic top view of a micro optical filter unit 200 of the matrix 120. As illustrated in FIG. 2, the micro optical filter unit 200 includes a unit frame 240, a micro optical filter assembly 300 (hereinafter “assembly 300”), a plurality of micro optical filter bearings 50 (hereinafter “filter bearings 50”), and a plurality of frame bearings 250.

Assembly 300 is attached via the filter bearings 50 to the unit frame 240 and can be tilted, rotated and other moved in order to switch the optical signals on the unit frame 240. The frame bearings 250 are immovably attached to the matrix board 130. As such the unit frame 240 in the same X-Y plane as the matrix board 130. The filter bearings 50 are bearing points by which assembly 300 moves Control and other electrical signals for assembly 300 may also wire through the filter bearings 50.

It is understood by people skilled in the art that assembly 300 is schematically and conceptually rendered in FIG. 2, in which it is represented by a shaded rectangular shape. As will be illustrated in more detail below in connection with the rest of the accompanying figures, it is noted that assembly 300 may have many different components and structures in the 3D space. The illustration of the 2D rectangular shape of the filter assembly 300 in FIG. 2 is by no means intended and should never be interpreted as limiting the shape, dimension or other geometrical features of assembly 300. Rather, people skilled in the art shall refer to the detailed description of the embodiments of the filter assembly 300 below.

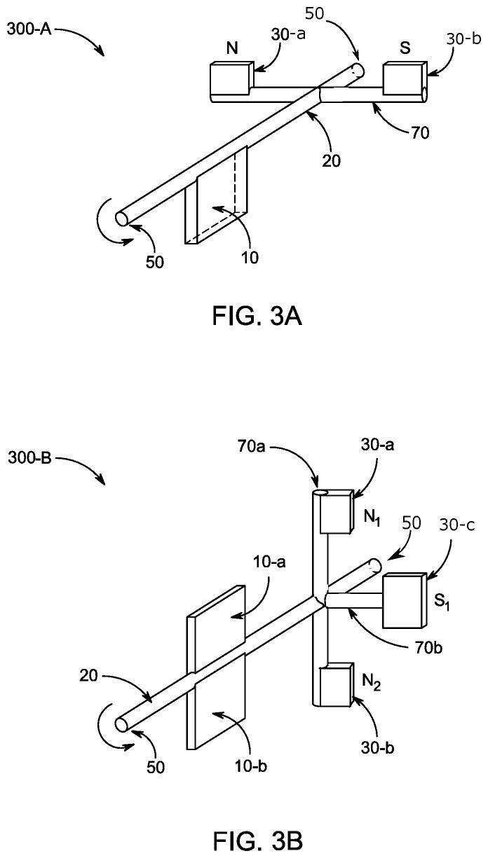

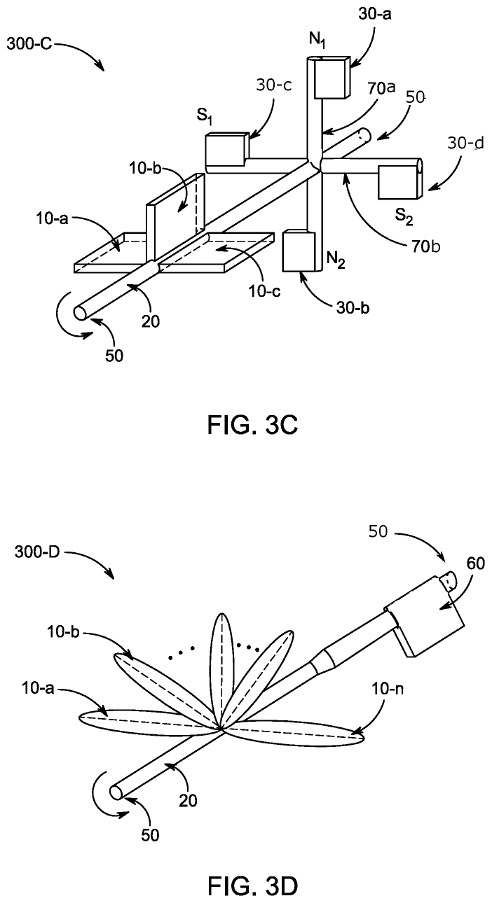

A plurality of embodiments of assembly 300 is now described in connection with FIGS. 3A-3D. FIGS. 3A-3D are perspective views of embodiments of the micro optical filter assembly 300. In FIGS. 3A-3D, the embodiments of micro filter assembly 300 are further identified with added alphabetic letters, i.e. 300-A, 300-B, 300-C and 300-D, in order to distinguish the embodiments from each other.

Referring to FIG. 3A, the assembly 300-A comprises a micro optical filter 10, a rotation shaft 20, a first magnetic tab 30-a of one of the N-S magnetic dipole, a second magnetic tab 30-b of the other dipole, filter bearings 50, and tail rod 70. The assembly 300-A as illustrated in FIG. 3A is in the inactive state, which will also the position the assembly 300-A be in when there is a power outage or otherwise no power in the system due to the gravity pull. Rotation shaft 20 is an elongated mechanical shaft that rotates freely between the filter bearings 50 and is central in activating or deactivating the micro optical filter unit 200. At approximately the middle part of rotation shaft 20, a micro optical filter 10 is fixedly attached thereto. With the rotation of the rotation shaft 20, micro optical filter 10 will then be moved up from the inactive space to the optical path space. When rotation shaft 20 rotates approximately 180 degrees from the inactive state, assembly 300-A will be in the activated state, wherein the micro optical filter 10 is placed in the optical path of incoming optical signals. Rotational degrees other than 180 degrees are also possible, as long as the optical filter 10 is rotated to a position where optical signals can be switched.

Towards one end of the rotation shaft 20, an elongated tail rod 70 is attached at its midpoint thereto, perpendicularly both to the rotation shaft 20 and the micro optical filter 10. Balanced on each end of tail rod 70 are two magnetic tabs. The first magnetic tab 30-a is of one of a magnetic dipole and the second magnetic tab 30-b is of the other dipole. As illustrated in FIG. 3A, the first tab 30-a is an N-pole and the second tab 30-b is an S-pole. Alternatively, the first tab 30-a is an S-pole and the second tab 30-b is an N-pole. The tabs may be of the same dipole as well. The tabs 30-a and 30-b are otherwise identical in shape, size and weight etc. It will be appreciated by people skilled in the art that the inactive state of the micro optical filter assembly 300-A is stable due to the balanced tabs 30-a and 30-b and the gravity pull.

At each end of rotation shaft 20, filter bearings 50 mechanically connect to the micro optical filter unit 200 as illustrated in FIG. 2. Filter bearings 50 are connected to the micro optical filter unit 200 in such a way that assembly 300-A may freely rotate along rotation shaft 20 according to control signals.

As described above, when the assembly 300-A is not active, micro optical filter assembly 300-A stays in the inactive position as illustrated in FIG. 3A. Micro optical filter assembly 300-A is activated by generating an electro-magnetic field that interacts with magnetic tabs 30-a and 30-b. More particularly, the MEMS micro optical filter switch system 100 includes components that generate and change micro magnetic fields around each of the assembly 300-A according to known art.

When the assembly 300-A needs to be activated, controller 140 will send control signal to actuate a magnetic field around the micro optical filter assembly 300-A according to known art. The magnetic field will interact the magnetic tabs 30-a and 30-b on tail rod 70 in such a way that it will push and/or pull the tabs and move them out of their current inactive locations. As a result, tail rod 70 starts to exert torsional forces at rotation shaft 20. Rotation shaft 20 will then start to rotate between the bearing points 50, which will turn the micro optical filter 10 out of the inactive space up towards the optical path space. The magnetic field is configured to stop the rotation and stabilize the assembly 300-A when the micro optical filter 10 is in the activated position where optical switching may be conducted. When the micro optical filter assembly 300-A needs to be deactivated, the controller 140 may simply send signals to withdraw the magnetic field around the assembly 300-A, which will automatically return to the inactive state due to gravity pull.

FIG. 3B is another embodiment of the micro optical filter assembly 300. Assembly 300-B is similar to assembly 300-A with a few modifications. Referring to FIG. 3B, the micro optical filter assembly 300-B includes two micro optical filters 10-a and 10-b, both attached to the rotation shaft 20 at the same distance from either ends of rotation shaft 20. They are 180 degrees separated from each other. The micro optical filters 10-a and 10-b are of the same shape, dimension and weight. However, they may have different optical filtering characteristics, the advantage of which will be described later. 300-B further includes a first magnetic tab 30-a, a second magnetic tab 30-b, a third magnetic tab 30-c, filter bearings 50, a full tail rod 70a and a half tail rod 70b. Tabs 30-a and 30-b are of same size, weight and shape and balanced on the ends of full tail rod 70a, similar to the embodiment of 3A. An additional half tail rod 70b is fixedly attached to the full tail rod 70a at its midpoint, wherein at the end of which another magnetic tab 30-c is attached. According to one embedment of 3B, 30-a and 30-b are of the N pole whereas 30-c is S pole. Other polarization of the tabs 30-a, 30-b and 30-c that will interact with a magnetic field and turn the assembly 300-B are also within the scope of the present invention.

The assembly 300-B's inactive state and activate states are as follows. When the assembly 300-B is inactive, it rests in a position where the first micro optical filter 10-a and the second micro optical filter 10-b are balanced on each side of the full tail rod 70a, parallel to the plane of the matrix board 130, which is a stable position of the assembly 300-B without an actuated magnetic field, or where there is no power or a power outage.

When the micro optical filter assembly 300-B is active, an actuated micro magnetic field around assembly 300-B will exert mechanical forces on the magnetic tabs 30-a, 30-b and 30-c, which will cause the rotation shaft 20 to turn, resulting in either the micro optical filter 10-a or 10-b being placed in the optical path space to switch the optical signals. Therefore, assembly 300-B has two active states. The magnetic field is configured to allow either one of the 10-a or 10-b to be placed on the optical path space for optical switching according to known art. The advantages 300-B is to provide additional switching options.

For example, micro optical filters 10-a and 10-b may be micromirrors configured with different incident and reflection angles. One of them may reflect an incident signal to 90 degrees, and the other to −90 degrees. As such, by activating either 10-a or 10-b, the assembly 300-B may switch the incident optical signal to either one of the transceiver pair on the same switched optical path, thus simplifying the implementation of an any-to-any switching capacity.

FIG. 3C illustrates another embodiment of the micro optical filter assembly 300. Assembly 300-C is similar to assembly 300-B and the description of embodiment of 300-C will be made by comparison of the two. Referring to FIG. 3C, the assembly 300-C includes 3 micro optical filters 10-a, 10-b and 10-c and one more magnetic tab 30-d is added comparing to 300-B. While the micro optical filters 10-a and 10-b are still located at the same distance from either ends of the rotation shaft 20 with a 180-degree angle across, the third micro optical filer 10-c is located right in between them and in an orthogonal orientation to them. Likewise, the additional magnetic tab 30-d is added at the end of the tail rod 70b. As such, the micro assembly 300-C has four magnetic tabs, with the adjacent tabs separated by 90 degrees.

Regarding the optical filters, according to one embodiment, the micro optical filters 10-a, 10-b and 10-c are of same shape, dimension and weight, but with different optical characteristic. According to another embodiment, the middle micro optical filter, namely 10-b in FIG. 3C, may be of a different shape, dimension or weight than 10-a and 10-b. When the assembly 300-C is inactive, micro filter 10-b will be perpendicularly suspended in the inactive space below the matrix board 130 with 10-a and 10-c balanced on either side.

Regarding the magnetic tabs 30-a, 30-b, 30-c and 30-d, according to a preferred embodiment, they are all of the same shape, dimension and weight. The polarization of the tabs can be any combination that do not impede the rotation of the rotation shaft 20 when the magnetic field is actuated. As such the assembly 300-C has 3 activated state with either 10-a, 10-b or 10-c placed on the optical paths, which provides further switching choices for the MEMS switch 100.

FIG. 3D is a perspective view of the assembly 300-D according to yet another embodiment of the present invention. Referring to FIG. 3D, the assembly 300-D comprises a multi-blade array of n micro optical filters 10-a, 10-b . . . 10-n, rotation shaft 20, filter bearings 50, and a micro stepper motor 60. While the rotation shaft 20, filter bearings 50 have the same functions as in embodiments 3A-3C, the operation of the micro optical filter assembly 300-D however does not depend on an actuated magnetic field to turn the rotation shaft 20 and activate of the micro optical filters. Instead, the rotation shaft 20 is fixedly attached to the shaft of the stepper motor 60. Stepper motor 60 can be configured to rotate at very small angles according to known art. In the embodiment of 300-D, the stepper motor 60 is configured to rotate to place each of the n micro optical filters 10 onto the optical path. When the assembly 300-D is in the inactive state, micro optical filter 10-a, 10-b, . . . , 10-n all stay in the inactive space. When the assembly 300-D is activated, the stepper motor 60 will place the selected filter according to the control signal provided by the controller 140 to the active position and angle to switch the optical signal. As people skilled in the art will appreciate, embodiment 300-D further expends the number of micro optical filters that can be used in the micro optical filter unit 200 and provides many more switching options than the previous embodiments.

The micro optical filters 10 throughout embodiments 300-A to 300-D can be any type of optical filters. They can be micromirrors, including total reflection micromirrors that reflect the entire spectrum of the optical signal they receive, selective pass micromirrors that reflect most spectrums but not certain wavelengths, or narrow band pass micro mirrors that only reflect selective bandwidth of the optical signal. In addition, the micro optical filters can be lenses that refract or allow to pass the whole or certain optical signals depending on the wavelength thereof The micro optical filters will be descried in more detail below.

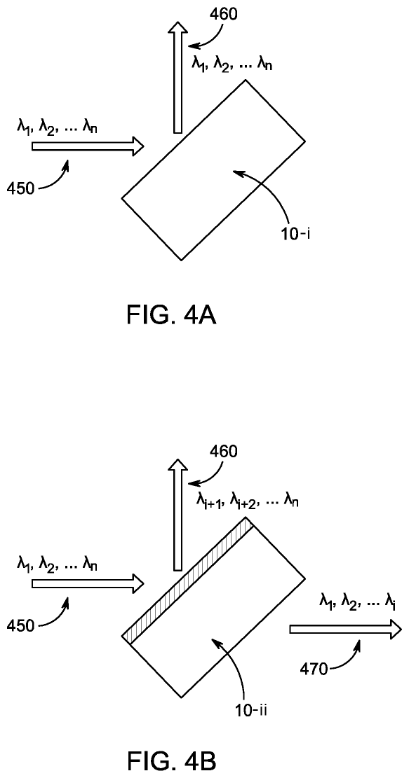

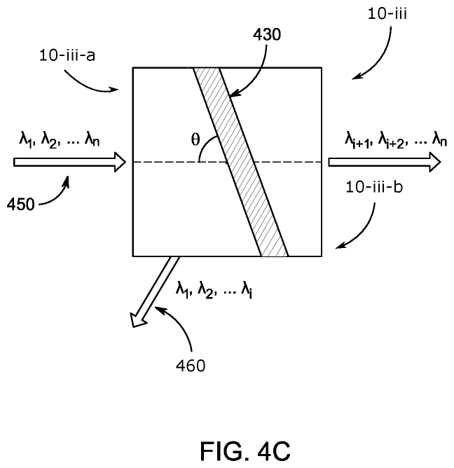

FIGS. 4A-4C are schematic side views of micro optical filters 10, which are various embodiments of micro optical filters 10 of FIGS. 3A-3D, according the present invention. To distinguish from the micro optical filters 10a-10d illustrated in FIG. 3A-3D, the micro filters 10 described in FIGS. 4A-4C are denoted by 10-i, 10-ii, and 10-iii respectively. Now referring to FIG. 4A, the micro optical filter 10-i is a micromirror. Referring to FIG. 4A, incident optical beam 450 consists of a number of wavelengths λ₁, λ₂, . . . , λₙ. With the reflection by micromirror 10-i, incident optical beam 450 is switched 90 degrees up. The reflected optical beam consists of wavelengths λ₁, λ₂, . . . , λₘ, wherein, if m=n, micromirror 10-i a total reflection micromirror; if m<n, micromirror 10-i is a selective pass micromirror; and if m<<n, micromirror 10-i is a narrow band micromirror.

In FIG. 4B, the micro optical filter 10-ii is a micro lens. Referring to FIG. 4B, incident optical beam 450 consists of wavelengths of λ₁, λ₂, . . . , λₙ is transmitted on its free space optical path. Coating 420 is applied on the surface of the micro lens 10-ii. With the appropriate coating 420 known in the art, wavelengths λ₁, λ₂, . . . , λᵢ of beam 470 pass through micro lens 10-ii and continue to travel in the same direction, whereas wavelengths λₙ₊₁, λᵢ₊₂, . . . , λₙ of beam 460 are reflected 90 degrees up to transceivers on the other axis. As such, the optical signal of beam 450 are separated and sent to two transceivers on the X-axis and the Y-axis respectively. The design and application of coating 420 on micro lens 10-ii is well-known in the art and people skilled in the art are able to select and apply the appropriate coating according to the range of wavelengths included in beams 450, 460 and 470.

In FIG. 4C, micro optical filter 10-iii comprises a first micro optical filter 10-iii-a, a second micro optical filter 10-iii-b and optical coating 430 applied between 10-iii-a and 10-iii-b. The first micro optical filter 10-iii-a and second micro optical filter 10-iii-b are two wedge-shaped lenses with matching tilted surfaces. When put together, the matching tilted surfaces of the 10-iii-a and 10-iii-b will be in full contact with each other with a titling angle θ. In between the tilted surfaces of 10-iii-a and 10-iii-b, coating 430 is applied. When incident optical beam 450 consisting of wavelengths of λ₁, λ₂, . . . , λₙ hits 10-iii, part of the wavelengths will hit the coating 430. Similar to embodiment 4B, coating 430 is configured to reflect some wavelength components and pass others. In the present embodiment, wavelengths λ₁, λ₂, . . . , λᵢ of beam 470 pass through micro lens 10-iii-a and 10-iii-b, whereas wavelengths λᵢ₊₁, λᵢ₊₂, . . . , λₙ of beam 460 are reflected. However, due to the tilting angle θ, beam 460 is reflected in an angular way to the side as illustrated in FIG. 4C. People skilled in the art will appreciate that, with the tilting angle θ, the reflected beam 460 can reach transceivers that are not in an optical path that is orthogonal to the incident beam. With the adjustment of the tilting angle θ, the receiving transceiver can be selected, thereby providing more flexibility in the implementation of the MEMS optical switch.

The embodiments of micro optical filters 10-iii illustrated in FIGS. 4A-4C can be applied in any combination to the assembly 300 in FIGS. 3A-3D. People skilled in the art will also appreciate the embodiments in FIGS. 4B and 4C will also enable adjustable power splitter ratio, signal monitoring and tapping by choosing the appropriate micromirrors or lenses that allows for different wavelengths of the incident beams to be reflected and pass the micro optical filter.

The MEMS switch 100 illustrated in FIG. 1 is a two-dimension switch with m xn micro optical filter units. The optical paths are all on the same 2D X-Y plane as illustrated therein. When m and n become big, the size of the MEMS switch 100 will increase accordingly. However, when the optical signals travel in the free space over a longer distance, the signal intensity and quality decreases rapidly. To solve the problem, a plurality of MEMS switch 100 as illustrated in FIG. 1 may be stacked together forming a 3D switch, which will be described in more detail below.

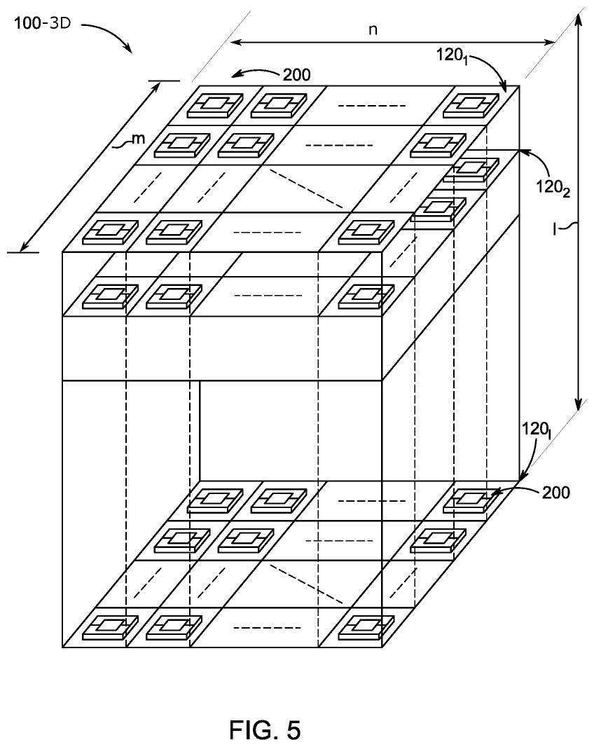

FIG. 5 is a schematic perspective view of a 3D MEMS micro optical filter switch according to an embodiment of the present invention. Referring to FIG. 5, the 3D MEMS micro optical filter switch 100-3D (hereinafter “the MEMS switch 100-3D”) comprises l layers of micro optical filter matrixes 120 with m×n micro optical filter units located on matrix boards 130 stacked on top of each other. The MEMS switch 100-3D can have as many as 2(m×l+n×l) transceivers transmitting and receiving optical signals at the same time (not shown in FIG. 5). There are m×n×l cross points in the 3D micro optical filter switch, wherein each cross point has a micro optical filter unit 200 located therein for switching. Each of the l layer of the 3D micro optical filter switch comprises m+n pairs of transceivers and operates in the same manner of the MEMS switch 100 as illustrated in FIG. 1. However, inter-layer transmission can also be achieved if special micro optical filters such as the one disclosed in FIG. 4C are used. By adjusting the tilting angle θ as described in connection with FIG. 4C, the reflective optical signals may go to a transceiver in a different layer in the 3D switch. As such, the 3D micro optical filter switch can be constructed. The inter-layer transmission will further increase the flexibility of the MEMS switch 100-3D.

It is appreciated by people of ordinary skill of the art that the present invention provides a non-intrusive any-to-any matrix based optical switch without channel interference.

For example, with regard to the 2D optical switch, any optical signals from an X-axis transceiver can be switched to any of the Y-axis transceivers and vice versa, wherein the optical paths of the signals do not interest or cross each other hence eliminating channel interference.

Another advantage of the present invention is that it provides an optical switch with fast switching speed in the range of micro- to mini-seconds due to the usage of the Electro-magnetic actuation or the stepper motors. In the meantime, the switching mechanism covers optical channel path change, wavelength selection and express channel for pass-through channels.

Yet another advantage of the present invention is to provide an optical switch using lens interface, wherein each lens interface may provide a multi-way channel cross-connect as illustrated in FIGS. 4A-4C

Yet another advantage of the present invention is to provide optical transmitters and receivers that can be individually replaced.

Yet another advantage of the present invention is that the optical switch can be extended to 3D and multi-directions using different layers of optical coatings on the lens.

Yet another advantage of the present invention is to provide an optical switch that can provide an adjustable power splitter ratio, signal monitoring and tapping.

Yet another advantage of the present invention is to provide a simplified channel array replaceable for any baud rate signal.

Yet another advantage of the present invention is to provide an optical switch, wherein each of the channels can be replaced or upgraded separately.

It is to be understood that the above description is intended to be illustrative and not restrictive. Many embodiments and applications other than the examples provided herein would be apparent upon reading the above description. The scope should be determined, not with reference to the above description, but with reference to the appended claims, along with the full scope of equivalents to which such claims are entitled. It is anticipated and intended that future developments will occur in the technologies discussed herein, and that the disclosed systems and methods will be incorporated into such future embodiments. That is, it should be understood that the application is capable of modification and variation. As such, the following claims are hereby incorporated into the Detailed Description of the Preferred Embodiments, with each claim standing on its own as a separately claimed subject matter.

What is claimed is:

1. A MEMS optical switch, comprising:
a plurality of optical transceivers in a 2D plane comprising an X-axis and a Y-axis with m pairs of optical transceivers lining along the Y-axis and n pairs of optical transceivers lining along the X-axis, wherein each transceiver of a pair is located on an optical path across an optical filter matrix of another transceiver of said pair;
the optical filter matrix comprising m xn micro optical filter units, wherein each micro optical filter unit is located on a cross point of optical paths of an X-axis transceiver pair and Y-axis transceiver pair;
an optical filter matrix board on which the optical filter matrix is located; and
a controller configured to provide MEMS control signals,
wherein each micro optical filter unit is configured to be able to be activated by the MEMS control signals and switching optical signals transmitted through the cross point where the micro optical filter unit is located.

2. The MEMS optical switch of claim 1, wherein each micro optical filter unit further comprising:
a micro optical filter assembly configured to be movable within a unit frame of said micro optical filter assembly.

3. The MEMS optical switch of claim 2, wherein the micro optical filter assembly comprising:
a rotation shaft; and
at least one micro optical filter attached to the rotation shaft,
wherein the rotational shaft is configured to be rotatable to place the at least one optical filter to one of an optical path space and an inactive space.

4. The MEMS optical switch of claim 3, wherein the micro optical filter assembly further comprising:
at least one tail rod; and
a plurality of magnetic tabs attached to the at least one tail rods, wherein at least one of the magnetic tabs is of a magnetic north and at least one of the magnetic tabs is of a magnetic south,
wherein an electro-magnetic field may be actuated in accordance with the MEMS control signal, said electro-magnetic filed interacts with the plurality of magnetic tabs and drives the rotation shaft to place one of the at least one micro optical filter to the optical path space.

5. The MEMS optical switch of claim 4, comprising one micro optical filter, and two magnetic tabs, wherein when the electro-magnetic field is not actuated, the micro optical filter is located in the inactive space.

6. The MEMS optical switch of claim 4, comprising two micro optical filters, and three magnetic tabs, wherein when the electro-magnetic field is not actuated, the two micro optical filters are located in the inactive space.

7. The MEMS optical switch of claim 4, comprising three micro optical filters, and four magnetic tabs, wherein when the electro-magnetic field is not actuated, the three micro optical filters are located in the inactive space.

8. The MEMS optical switch of claim 3, wherein the micro optical filter assembly further comprising:
a stepper motor attached to the rotation shaft,
wherein the stepper motor is configured to drive the rotation shaft to place one of the at least one micro optical filter to the optical path space.

9. The MEMS optical switch of claim 3, wherein the micro optical filter assembly further comprising:
a stepper motor attached to the rotation shaft,
wherein the stepper motor is configured to drive the rotation shaft to place one of the at least one micro optical filter to the optical path space.

10. The MEMS optical switch of claim 3, wherein the at least one micro optical filter comprises a micromirror.

11. The MEMS optical switch of claim 3, wherein the at least one micro optical filter comprises a coated micro lens, wherein the coated micro lens reflects a first plurality of wavelengths and passes a second plurality of wavelengths.

12. The MEMS optical switch of claim 3, wherein the at least one micro optical filter comprises two micro lenses in contact with each other on a tilted coated surface with a tilting angle θ, wherein the micro optical filter reflects a first plurality of wavelength to an angle adjusted by the tilting angle θ and passes a second plurality of wavelengths.

13. A MEMS optical switch, comprising:
a plurality of free space optical paths in a 2D plane comprising an X-axis and a Y-axis with m horizontal optical paths and n vertical optical paths;
l pairs of optical transceivers located on the m horizontal paths, wherein l<m, and k pairs of optical transceivers located on the n horizontal paths, wherein k<n, wherein each transceiver is located on an optical path across an optical filter matrix of another transceiver of said pair, and wherein at least one pair of the l pairs of transceivers and the k pairs of vertical optical is configured to be moveable and transmits optical signals on at least two optical paths;
the optical filter matrix comprising m xn micro optical filter units, wherein each micro optical filter unit is located on a cross point of optical paths of an X-axis transceiver pair and Y-axis transceiver pair;
an optical filter matrix board on which the optical filter matrix is located; and
a controller configured to provide MEMS control signals,
wherein each micro optical filter unit is configured to be able to be activated by the MEMS control signals and switching optical signals transmitted through the cross point where the micro optical filter unit is located.

14. The MEMS optical switch of claim 13, wherein each micro optical filter unit further comprising:
a micro optical filter assembly configured to be movable within a unit frame of said micro optical filter assembly.

15. The MEMS optical switch of claim 14, wherein the micro optical filter assembly comprising:
a rotation shaft; and
at least one micro optical filter attached to the rotation shaft;
wherein the rotational shaft is configured to be rotatable to place the at least one optical filter to one of an optical path space and an inactive space.

16. The MEMS optical switch of claim 15, wherein the micro optical filter assembly further comprising:
at least one tail rod; and
a plurality of magnetic tabs attached to the at least one tail rods, wherein at least one of the magnetic tabs is of a magnetic north and at least one of the magnetic tabs is of a magnetic south,
wherein an electro-magnetic field may be actuated in accordance with the MEMS control signal, said electro-magnetic field interacts with the plurality of magnetic tabs and drives the rotation shaft to place one of the at least one micro optical filter to the optical path space.

17. The MEMS optical switch of claim 15, wherein the micro optical filter assembly comprising:
a stepper motor attached to the rotation shaft,
wherein the stepper motor is configured to drive the rotation shaft to place one of the at least one micro optical filter to the optical path space.

18. The MEMS optical switch of claim 15, wherein the at least one micro optical filter comprises two micro lenses in contact with each other on a tilted coated surface with a tilting angle θ, wherein the micro optical filter reflects a first plurality of wavelength to an angle adjusted by the tilting angle θ and passes a second plurality of wavelengths.

19. A 3D MEMS optical switch, comprising:
a plurality of optical transceiver layers, each layer comprising:
a plurality of optical transceivers in a 2D plane comprising an X-axis and a Y-axis with m pairs of optical transceivers lining along the Y-axis and n pairs of optical transceivers lining along the X-axis, wherein each transceiver of a pair is located on an optical path across an optical filter matrix of another transceiver of said pair;
the optical filter matrix comprising m×n micro optical filter units, wherein each micro optical filter unit is located on a cross point of optical paths of an X-axis transceiver pair and Y-axis transceiver pair;
an optical filter matrix board on which the optical filter matrix is located; and
a controller configured to provide MEMS control signals;
wherein each micro optical filter unit is configured to be able to be activated by the MEMS control signals and switching optical signals transmitted through the cross point where the micro optical filter unit is located.

20. The MEMS optical switch of claim 19, wherein an optical filter unit is further configured to be able to switch optical signals transmitted from a first transceiver located in a first layer of the MEMS optical switch to a second transceiver located in a second layer of the MEMS optical switch.
